(19) United States
(12) Patent Application Publication
(10) Pub. No.: US 2010/0123870 A1
(43) Pub. Date: May 20, 2010

(54) Structure of a frame combination of eyeglasses

(76) Inventor: Jui-Chi Li, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/292,420

(22) Filed: Nov. 19, 2008

(51) Int. Cl. G02C 9/00

(52) U.S. Cl. 351/57

(57) ABSTRACT

Eyeglasses include a main frame, and a secondary frame joined on a rear side of the main frame; the main frame is a half-rimmed one, and used to hold dark glasses; the secondary frame is a completely-rimmed one, and used to hold eyesight-assisting lenses; the main frame has two middle joining recessed portions, and a joining piece on each of lateral parts thereof; the secondary frame has two joining plates on a front side, which are joined to the joining recessed portions of the main frame respectively; the secondary frame has raised joining portions, which are joined to the joining pieces of the main frame respectively; therefore, not only can the eyeglasses protect the wearer's eyes from the sun's glare, they can assist the wearer's eyesight as well.

### BACKGROUND OF THE INVENTION

1. Field of the Invention

The present invention relates to a frame combination structure of eyeglasses, more particularly one, which allows dark glasses as well as sight-assisting lenses to be joined thereon; thus, not only can the eyeglasses protect the wearer's eyes from the sun's glare, they can assist the wearer's eyesight as well.

2. Brief Description of the Prior Art

Currently, the proportion of shortsighted people is much greater than that several decades ago. And, the number of children who have shortsightedness is rapidly increasing. People with nearsightedness or farsightedness usually have to wear glasses to assist their eyesight. And, many people, e.g. sportsmen, exercisers, factory workers, and motorcyclists, wear safety glasses/goggles or sport and leisure glasses to protect their eyes when they are engaged in certain activities. And, sunglasses are widely used to protect the eyes from the sun's glare.

Furthermore, those people who like pursue fashionable things wear novel glasses to match their clothing. Therefore, eyeglasses have become a kind of daily necessities. Therefore, the eyeglasses industry makes a large variety of novel and fancy eyeglasses to meet consumers' different needs.

However, most of the currently existing sight-assisting lenses can't prevent the wearers' eyes from being hurt or injured by strong sunlight. And, most of the currently existing dark glasses can't correct poor eyesight. Consequently, a nearsighted person will have a problem in wearing his/her eyeglasses if he has to go outdoors when the sunlight is very strong.

### SUMMARY OF THE INVENTION

It is a main object of the present invention to provide a frame combination of eyeglasses to overcome the above problems; the frame combination is structured in such a manner that dark glasses and sight-assisting lenses can be held thereon at the same time; thus, not only can the eyeglasses protect the wearer's eyes from the sun's glare, they can assist the wearer's eyesight as well.

A frame combination of eyeglasses in accordance with an embodiment of the present invention includes a main frame, and a secondary frame next to a rear side of the main frame. The main frame is a half-rimmed one, and holds dark glasses thereon; the secondary frame is a completely-rimmed one, and holds eyesight-assisting lenses thereon.

The main frame has two middle joining recessed portions, and a joining piece on each of its lateral parts. The secondary frame has two middle joining plates on a front side, and a raised joining portion on each of its two ends. The secondary frame is joined on the main frame with the joining plates being embedded in the joining recessed portions, and with the raised joining portions being joined in the joining pieces of the main frame respectively.

### BRIEF DESCRIPTION OF THE DRAWINGS

The present invention will be better understood by referring to the accompanying drawings, wherein:

FIG. 1 is an exploded perspective view of the present invention,

FIG. 2 is a front view of the present invention, and

FIG. 3 is a side view of the present invention.

### DETAILED DESCRIPTION OF THE PREFERRED EMBODIMENTS

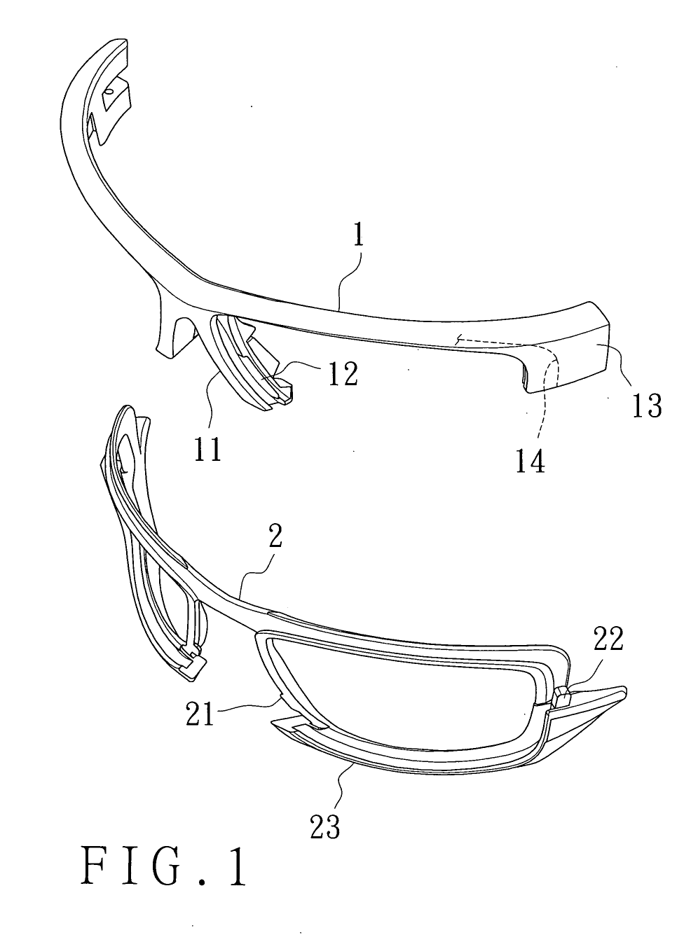

Referring to FIG. 1, a preferred embodiment of a frame combination of eyeglasses of the present invention includes a main frame 1, and a secondary frame 2.

The main frame 1 is a half-rimmed one, and dark glasses and temples are joined on the main frame 1. The main frame 1 includes a middle part 11, and two lateral parts 13. The middle part 11 includes two joining recessed portions 12. Each of the lateral parts 13 of the main frame 1 has a joining piece 14 thereon.

The secondary frame 2 is a completely-rimmed one, and joined on the main frame 1. And, lenses are joined on the secondary frame 2 to assist the eyesight of the wearer. The secondary frame 2 has two joining plates 21 on a front side thereof, which are provided for connection with the joining recessed portions 12 of the main frame 1. The secondary frame 2 has raised joining portions 22 for connection with the joining pieces 14 of the main frame 1. Furthermore, the secondary frame 2 has a protruding part 23 on a lower edge thereof.

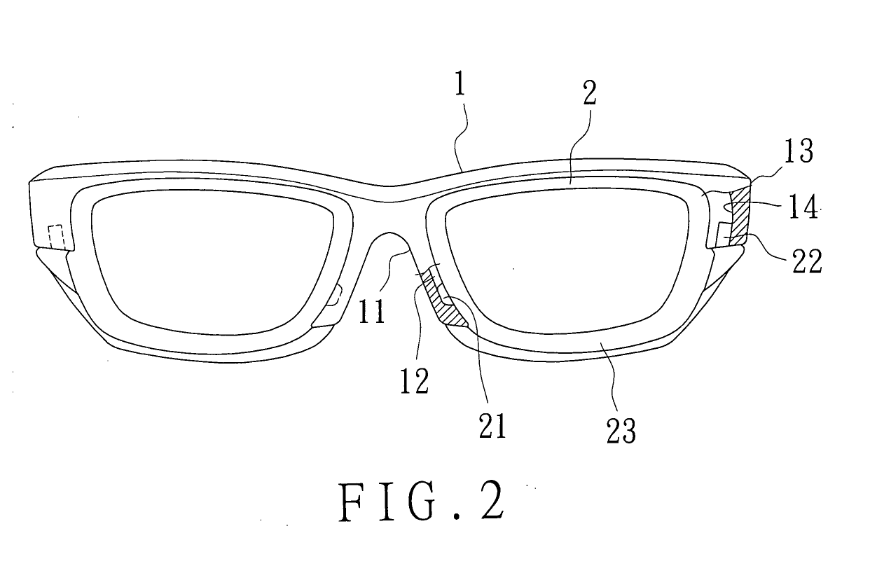

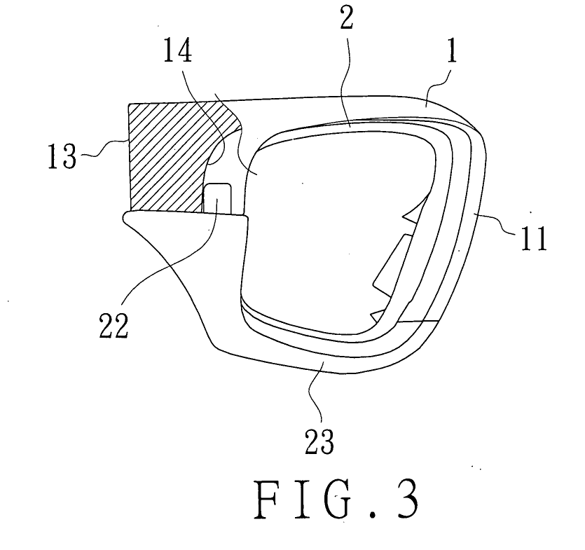

In assembly, referring to FIGS. 2 and 3, the secondary frame 2 is positioned on a rear side of the main frame 1 such that the joining plates 21 are embedded in the joining recessed portions 12, the raised joining portions 22 are joined in the joining pieces 14, and the protruding part 23 of the secondary frame 1 is under the main frame 1; thus, the main frame 1 together with the protruding part 23 of the secondary frame 2 comprise a completely-rimmed frame.

The main frame 1 has dark glasses joined thereon to protect the wearer's eyes from the sun's glare, and the secondary frame 2 has lenses thereon to assist the wearer's eyesight. Therefore, the eyeglasses with the frame combination of the present invention can protect the wearer's eyes from the sun's glare, and can assist the wearer's eyesight as well.

From the above description, it can be seen that the present invention has the following advantages over the prior art:

1. The main frame of the eyeglasses has dark glasses thereon to protect the wearer's eyes from the sun's glare, and the secondary frame has lenses thereon to assist the wearer's eyesight. Therefore, not only can the eyeglasses of the present invention protect the wearer's eyes from the sun's glare, they can assist the wearer's eyesight as well.

2. When the main frame and the secondary frame are joined together, the half-rimmed main frame together with the protruding part of the secondary frame will comprise a completely-rimmed frame.

What is claimed is:

1. Structure of a frame combination of eyeglasses, comprising
a main frame, the main frame having two joining recessed portions on a middle thereof; the main frame having a joining piece on each of lateral parts thereof; and
a secondary frame joined on a rear side of the main frame; the secondary frame having two joining plates on a front side thereof, which are joined to the joining recessed portions of the main frame respectively; the secondary frame having raised joining portions, which are joined to the joining pieces of the main frame respectively.

2. The structure of a frame combination of eyeglasses as claimed in claim 1, wherein the main frame is a half-rimmed one, and the secondary frame is a completely-rimmed one; the secondary frame having a protruding part on a lower edge thereof; the protruding part of the secondary frame being joined on a bottom of the main frame.
